(19) United States
(12) Patent Application Publication
(10) Pub. No.: US 2009/0135146 A1
(43) Pub. Date: May 28, 2009

(54) Touch screen with resistive electrode

(75) Inventor: William F. Scholz, Phoenix, AZ (US)

Correspondence Address: Paul F. Wille;Cantor Colburn, LLP, 22nd Floor, 20 Church St., Hartford, CT, 06103, US

(73) Assignee: World Properties, Inc., Lincolnwood, IL (US)

(21) Appl. No.: 11/986,924

(22) Filed: Nov. 27, 2007

(51) Int. Cl. G06F 3/041

(52) U.S. Cl. 345/173

(57) ABSTRACT

A touch screen includes a resistive layer made from conductive ink and overlying at least a portion of a substrate. The resistive layer has a sheet resistance of 1,000-5,000 Ω/ [symbol] In one embodiment of the invention, the touch screen is transparent. The touch screen also includes a patterned conductive layer for linearizing current and an insulating layer overlying the patterned conductive layer and the resistive layer.

### FIELD OF THE INVENTION

This invention relates to a capacitive touch screen including a resistive electrode having a sheet resistance of 1,000 Ω/ [symbol] -5,000 Ω/ [symbol] (ohms per square).

### BACKGROUND OF THE INVENTION

A touch screen is an electronic sheet that converts touch into one or more electrical signals. Early versions of a touch screen sometimes used a special stylus. Some touch screens are opaque but most are transparent. A transparent touch screen typically overlies a display and allows the display to be used as an input device, eliminating the need for a keypad and mouse. Displays combined with touch screens are used in many diverse applications, such as cellphones, media players, appliances, instrument panels, and point of sale terminals.

There are several kinds of touch screens, including surface acoustical wave (SAW), infrared, resistive, and capacitive. Among capacitive touch screens, there are generally two types, sheet capacitance and plural conductive bars across a surface. Examples of the latter are disclosed in U.S. Pat. No. 5,650,597 (Redmayne) and U.S. Pat. No. 6,961,049 (Mulligan et al.).

Sheet capacitance uses a relatively linear electric field created across the surface of a touch screen. “Capacitance” is a bit of a misnomer. The sheet includes a resistive layer overlying a substrate and acting as an electrode. A voltage gradient is created among the corners of the resistive layer. An insulating layer over the resistive layer prevents direct contact with the resistive layer. A finger or stylus is capacitively coupled to the resistive layer, to which alternating current is applied.

Linear means that “a uniform current density can be produced throughout a surface of uniform resistivity by connecting appropriate voltages to the edge terminations” [of the surface], a definition that appears in U.S. Pat. No. 4,371,746 (Pepper, Jr.) and appears to be accepted in the art. Touch is sensed when the current density is modified by a user's finger draining charge from the sheet. See, also, for example, U.S. Pat. No. 4,806,709 (Evans), and U.S. Pat. No. 5,940,065 (Babb et al.).

A touch screen based upon sheet capacitance requires a single continuous layer of transparent conductor (the resistive layer) and can be used for small or large touch screens. Electrodes around the periphery of the resistive layer provide a linear gradient and much work has gone into optimizing linearity; e.g. see U.S. Pat. No. 6,506,983 (Babb et al.), U.S. Pat. No. 6,549,193 (Huang et al.), and U.S. Pat. No. 6,781,579 (Huang et al.).

For transparent touch screens, it is known in the art to make the resistive layer from antimony oxide, indium oxide, tantalum oxide, tin oxide, or indium tin oxide. There are disclosures in the prior art of extraordinary ranges for resistance, e.g. 10-50,000 Ω/ [symbol] These are for opaque touch screens. A more credible range in the prior art is 300-500 Ω/ [symbol] for an indium tin oxide (ITO) layer in a transparent touch screen. Generally, ITO layers are sputtered and their thickness is measured in angstroms. A layer of ITO is typically sputtered on a glass substrate, although other substrates are disclosed in the prior art, at least for opaque touch screens. With thicknesses measured in angstroms (tenths of a nanometer), these are known as thin film devices.

For opaque sensors, it is known in the art to screen print a resistive ink for the resistive layer; e.g. see U.S. Pat. No. 6,163,313 (Aroyan et al.). U.S. Pat. No. 5,650,597 (Redmayne) appears to disclose (the text is not clear) a roll coated ITO layer that is patterned into bars extending in the direction of the roll coating. With thickness measured in mils (hundredths of a millimeter), known ink based conductive layers are thick film devices.

The resistance of sputtered ITO is typically less than ˜1000 Ω/ [symbol] Decreasing the thickness of an ITO layer to increase its resistance causes pinholes and inconsistencies that adversely affect performance. Organic, low conductivity coatings may not be transparent enough for transparent touch screens. The resistive layer should be substantially clear for a transparent touch screen.

While suitable materials have long been available, there is a continuing problem of cost. A linear gradient presumes a uniform resistive layer. The resistance of the layer affects the ability to detect touch. A resistance that is too high or too low requires sophisticated electronics for detecting touch reliably, if it can be done at all. Resistance also affects power consumption. One cannot simply use a layer of given resistance without considering the opacity of the layer. Given all these considerations, it remains a problem to find a suitable resistive layer.

In view of the foregoing, it is therefore an object of the invention to provide an improved capacitive touch screen.

Another object of the invention is to provide a low cost resistive layer for a capacitive touch screen.

A further object of the invention is to provide a low cost resistive layer of uniform resistivity.

Another object of the invention is to provide a low cost resistive layer having a resistance of 500-5,000 Ω/ [symbol] and preferably 1,000-2,000 Ω/

[symbol]

A further object of the invention is to provide a low cost resistive layer that has a resistance of 500-5,000 Ω/ [symbol] and that transmits ninety percent of light that is incident normal to the layer.

### SUMMARY OF THE INVENTION

The foregoing objects are achieved by this invention in which a touch screen includes a resistive layer made from conductive ink and overlying at least a portion of a substrate. The resistive layer has a sheet resistance of 1,000-5,000 Ω/ [symbol] In one embodiment of the invention, the touch screen is transparent. The touch screen also includes a patterned conductive layer for linearizing current and an insulating layer overlying the patterned conductive layer and the resistive layer.

### BRIEF DESCRIPTION OF THE DRAWINGS

A more complete understanding of the invention can be obtained by considering the following detailed description in conjunction with the accompanying drawings, in which:

FIG. 1 is a plan view of a touch screen based upon U.S. Pat. No. 4,198,539 (Pepper, Jr.) and showing peripheral conductors for improving linearity;

FIG. 2 is a perspective view of a touch screen and an imaginary chart illustrating the distortion of a voltage gradient caused by touch; and

FIG. 3 is a cross-section of a touch screen constructed in accordance with a preferred embodiment of the invention.

The figures are not drawn to scale but merely illustrate various aspects of the invention.

### DETAILED DESCRIPTION OF THE INVENTION

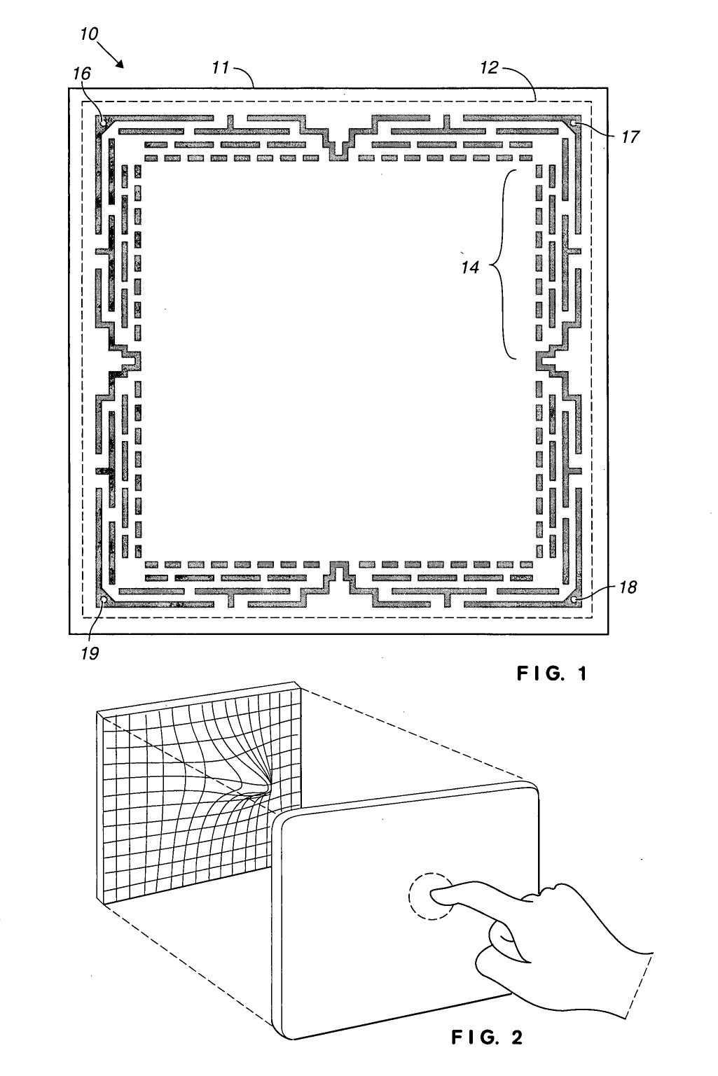

Touch panel 10 includes an insulating, transparent substrate 11 coated with layer 12 of transparent, resistive material. Although illustrated as a square substrate with a square resistive layer, other shapes can be used. Overlying resistive layer 12 is a pattern of conductive strips for linearizing current. The strips are in a repeating pattern, as represented by pattern 14 along the upper, right hand edge of resistive layer 12. An insulating layer, not shown in FIG. 1, overlies at least resistive layer 12.

The outermost conductive strips are joined at corners 16, 17, 18, and 19, forming terminals for applying voltage to resistive layer 12. The four corners are electrically connected to a circuit (not shown) for supplying current, detecting current, and calculating position from changes in current when the insulating layer is touched. When the surface of the insulating layer is touched by a user's finger, current flows into or out of the user's body, unbalancing the current normally flowing through the corner terminals. The change in current is indicative of position.

FIG. 2 is a perspective view of a touch screen and an imaginary chart illustrating the distortion of a voltage gradient caused by touch. Additional current is supplied from all four corners but the amount of additional current depends upon distance from the point of contact, which enables position to be determined.

Despite the pattern of conductive strips, there is an unstated presumption that layer 12 (FIG. 1) has uniform thickness and uniform resistivity. For an ink based layer, resistivity is uniform if the conductive particles have uniform density across the area of the layer. In accordance with the invention, uniform thickness and uniform resistivity are obtained by roll coating a layer of conductive ink to produce a sheet resistance of 1,000 Ω/ [symbol] -5,000 Ω/

[symbol]

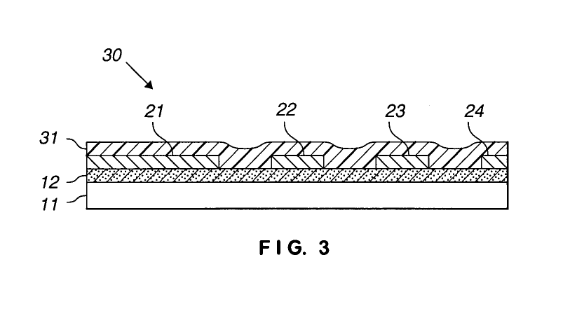

FIG. 3 is a cross-section of a touch screen constructed in accordance with a preferred embodiment of the invention. Substrate 11 is preferably polycarbonate or other dimensionally stable, clear plastic, such as PET. Resistive layer 12 is preferably roll coated from a UV curable resin containing particles of ITO. The thickness of the resistive layer can be varied from about 300 nm to about 1000 nm. A sheet of material, made for the transparent electrode of electroluminescent lamps, is available from Sumitomo Metals and Mining (SMM) under the trade name “STFlex”.

Uniform resistivity is obtained by thorough mixing of the ink until delivery to the roll coating station. Roll coating can provide uniform thickness by controlling flow, the aperture of the blade, and spacing from substrate 11 during application. These are readily determined empirically for a given ink. Sheet resistance varies inversely with thickness. That is, a thinner resistive layer has a higher resistance than a thicker resistive layer.

After resistive layer 12 is deposited and cured or dried, conductive strips 21, 22, 23, and 24 are applied by screen printing, thermal printing, or other means. Transparent, insulating layer 31 is then applied, preferably by screen printing.

In an alternative embodiment of the invention, resistive layer 12 is screen printed from ink containing particles of acicular ITO. Acicular ITO is known in the art as a transparent conductor; see U.S. Pat. No. 5,580,496 (Yukinobu et al.) and the divisional patents based thereon (U.S. Pat. Nos. 5,820,843, 5,833,941, 5,849,221). Acicular ITO has a fibrous structure composed of 2-5 μm thick by 15-25 μm long ITO needles. The needles are suspended in an organic resin, e.g. polyester.

A cured, screen printed layer of acicular ITO is approximately five times more conductive than conventional layers containing ITO powder but is about two thirds less conductive than sputtered ITO. Thus, acicular ITO can be formulated to provide a resistance of 1,000 Ω/ [symbol] to 5,000 Ω/ [symbol] Antimony tin oxide is less conductive than acicular ITO, is also suitable, and is less expensive than acicular ITO.

The invention thus provides an improved capacitive touch screen having a low cost resistive layer of uniform resistance in the range of 1,000-5,000 Ω/ [symbol] and preferably 1,000-2,000 Ω/ [symbol] The resistive layer transmits ninety percent of light that is incident normal to the layer.

Having thus described the invention, it will be apparent to those of skill in the art that various modifications can be made within the scope of the invention. For example, other layers can be added to the embodiment shown in FIG. 3, such as a fixed graphic overlay. A touch screen can be made from heat curable (solvent based) or UV curable resins. A very flexible substrate can be obtained by using a UV curable resin such as Lustercure Special Coat C, as sold by Kolorcure Corp. The substrate is formed on a release layer that supports the substrate while the resistive layer, conductive strips, and insulating layer are applied. Gravure coating or other methods for applying a coating can be used instead of roll coating or screen printing.

What is claimed is:

1. A touch screen comprising:
a substrate;
a resistive layer overlying at least a portion of said substrate;
wherein said resistive layer is a cured, conductive ink having a sheet resistance of 1,000-5,000 Ω/ [symbol]
a patterned, conductive layer overlying said resistive layer; and
an insulating layer overlying said resistive layer.

2. The touch screen as set forth in claim 1 wherein said substrate, said resistive layer, and said insulating layer are transparent.

3. The touch screen as set forth in claim 2 wherein said resistive layer is a resin containing particles of indium tin oxide.

4. The touch screen as set forth in claim 1 wherein said resistive layer is a resin containing particles of indium tin oxide.

5. The touch screen as set forth in claim 1 wherein said ink is heat curable.

6. The touch screen as set forth in claim 1 wherein said ink is UV curable.

7. The touch screen as set forth in claim 1 wherein said substrate is a UV curable resin.
